(19) United States
(12) Patent Application Publication
(10) Pub. No.: US 2013/0162017 A1
(43) Pub. Date: Jun. 27, 2013

(54) ADAPTER

(71) Applicants: SZU-LUN HUANG, Tu-Cheng (TW); CHIH-HUANG WU, Tu-Cheng (TW)

(72) Inventors: SZU-LUN HUANG, Tu-Cheng (TW); CHIH-HUANG WU, Tu-Cheng (TW)

(73) Assignee: HON HAI PRECISION INDUSTRY CO., LTD., Tu-Cheng (TW)

(21) Appl. No.: 13/442,937

(22) Filed: Apr. 10, 2012

(30) Foreign Application Priority Data
Dec. 23, 2011 (TW) 100148481

(51) Int. Cl. H04B 3/54

(52) U.S. Cl. 307/1

(57) ABSTRACT

An institute of electrical and electronics engineers (IEEE) 1394 device adapter includes first and second conversion circuits, a switch unit, and an IEEE1394 interface. The first conversion circuit includes a digital to analog (D/A) converter and a coupler. The second conversion circuit includes an analog to digital (A/D) converter and a decoupler. When the switch unit connects the first conversion circuit to the IEEE1394 interface, the D/A converter converts an data signal into a first carrier signal. The coupler couples the first carrier signal to an alternating current (AC) voltage. When the switch unit connects the second conversion circuit to the IEEE1394 interface, the decoupler divides an AC voltage coupled with a second carrier signal into the second carrier signal. The A/D converter converts the second carrier signal into a data signal, and outputs to the IEEE1394 interface.

### CROSS-REFERENCE TO RELATED APPLICATIONS

Relevant subject matter is disclosed in the co-pending U.S. patent applications (Attorney Docket Nos. US42533, US42534, US42535, US42536, US42537, US42538, US42539, US42540, US42541, and US42542) having the same title and assigned to the same assignee as named herein.

### TECHNICAL FIELD

The present disclosure relates to adapters, and particularly, to an institute of electrical and electronics engineers (IEEE) 1394 device adapter.

### DESCRIPTION OF RELATED ART

Generally, IEEE1394 devices communicate with other IEEE1394 devices through IEEE1394 interfaces of computers. If there is no computer, the IEEE1394 devices cannot communicate with other IEEE1394 devices. Therefore, there is an undesirable limit to the use of the IEEE1394 devices.

### BRIEF DESCRIPTION OF THE DRAWINGS

Many aspects of the present embodiments can be better understood with reference to the following drawings. The components in the drawing are not necessarily drawn to scale, the emphasis instead being placed upon clearly illustrating the principles of the present disclosure. Moreover, in the drawings, all the views are schematic, and like reference numerals designate corresponding parts throughout the several views.

FIG. 1 is a schematic view of an exemplary embodiment of an institute of electrical and electronics engineers (IEEE) 1394 device adapter, wherein the IEEE1394 device adapter includes a voltage conversion circuit.

FIG. 2 is a block diagram of the IEEE1394 device adapter of FIG. 1.

FIG. 3 is a block diagram of the voltage conversion circuit of FIG. 1.

FIG. 4 is a schematic view of the IEEE1394 device adapter communicating with another IEEE1394 device adapter.

FIG. 5 is a block diagram of the devices of FIG. 4.

### DETAILED DESCRIPTION

The disclosure, including the accompanying drawings in which like references indicate similar elements, is illustrated by way of example and not by way of limitation. It should be noted that references to “an” or “one” embodiment in this disclosure are not necessarily to the same embodiment, and such references mean at least one.

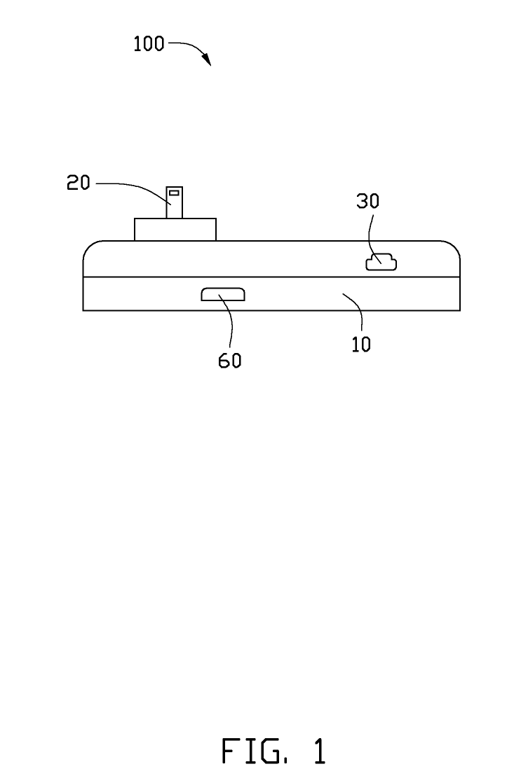

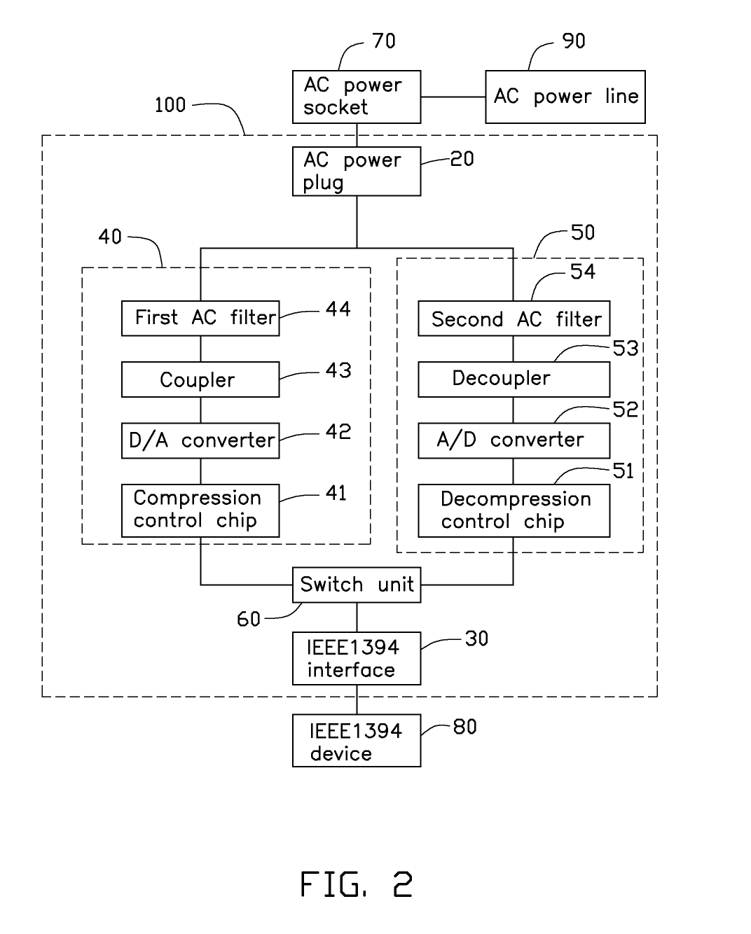

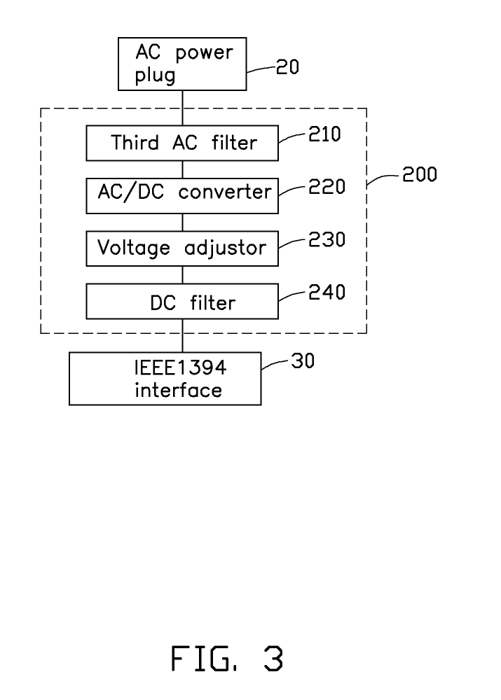

Referring to FIGS. 1 to 3, an embodiment of an institute of electrical and electronics engineers (IEEE) 1394 device adapter 100 includes an enclosure 10, an alternating current (AC) power plug 20, an IEEE1394 interface 30, a first conversion circuit 40, a second conversion circuit 50, a switch unit 60, and a voltage conversion circuit 200. The AC power plug 20 is mounted on the enclosure 10 to be connected to an AC power socket 70. The IEEE1394 interface 30 is mounted on the enclosure 10 to be connected to an IEEE1394 device 80. The switch unit 60 is connected between the IEEE1394 interface 30 and each of the first and second conversion circuits 40 and 50, to connect either the first conversion circuit 40 or the second conversion circuit 50 to the IEEE1394 interface 30. When the IEEE1394 device 80 connected to the IEEE1394 device adapter 100 functions as a signal transmission terminal, the switch unit 60 connects the first conversion circuit 40 to the IEEE1394 interface 30. When the IEEE1394 device 80 connected to the IEEE1394 device adapter 100 functions as a signal receiving terminal, the switch unit 60 connects the second conversion circuit 50 to the IEEE1394 interface 30. In the embodiment, the switch unit 60 is a manual switch.

The first conversion circuit 40 includes a compression control chip 41, a digital to analog (D/A) converter 42, a coupler 43, and a first AC filter 44. The second conversion circuit 50 includes a decompression control chip 51, an analog to digital (A/D) converter 52, a decoupler 53, and a second AC filter 54.

The compression control chip 41 is connected to the switch unit 60. The D/A converter 42 is connected between the compression control chip 41 and the coupler 43. The coupler 43 is connected to the AC power plug 20 though the first AC filter 44. The AC power plug 20 is also connected to the decoupler 53 through the second AC filter 54. The A/D converter 52 is connected between the decoupler 53 and the decompression control chip 51. The decompression control chip 51 is connected to the switch unit 60.

The voltage conversion circuit 200 includes a third AC filter 210, an alternating current to directing current (AC/DC) converter 220, a voltage adjustor 230, and a DC filter 240. In view of the likelihood of random noise in the AC voltage, the third AC filter 210 is connected to the AC power plug 20 to receive the AC voltage, and filters the noise from the AC voltage. The AC/DC converter 22 is connected between the third AC power filter 210 and the voltage adjustor 230, to convert the AC voltage into a DC voltage, and outputs the DC voltage to the voltage adjustor 230. The voltage adjustor 230 adjusts the received DC voltage. In view of the possibility of random noise in the adjusted DC voltage, the DC filter 240 is connected between the voltage adjustor 230 and the IEEE1394 interface 30 to filter the noise from the adjusted DC voltage and output the filtered DC voltage to the IEEE1394 interface 30, to power the IEEE1394 device 80 connected to the IEEE1394 interface 30.

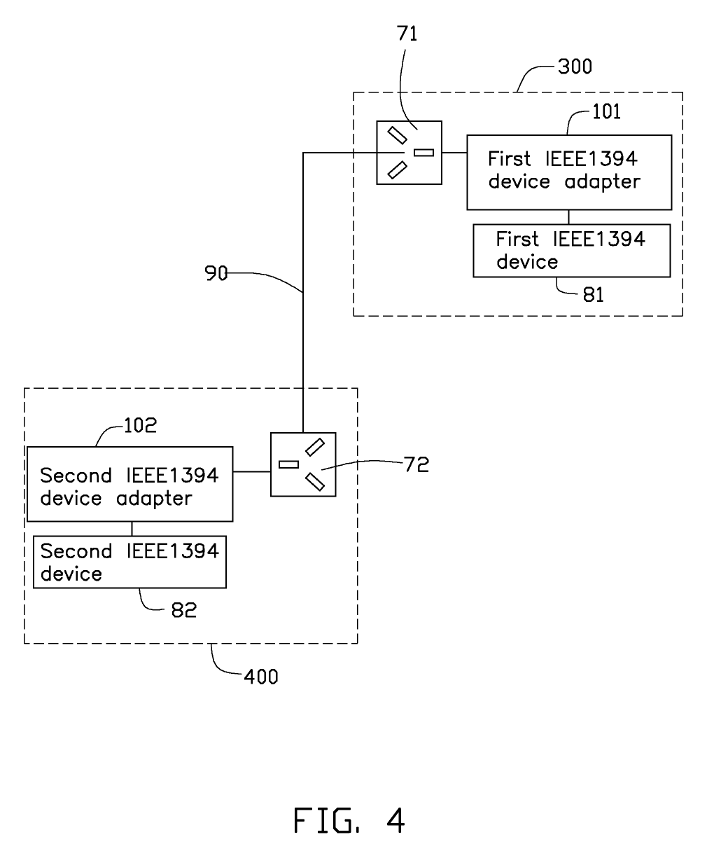

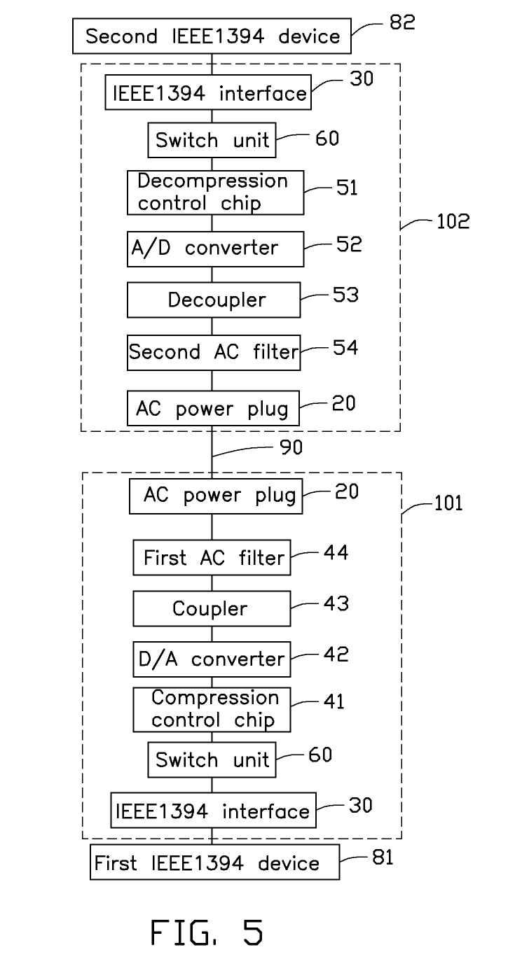

Referring to FIGS. 4 and 5, an example is taken to describe a working principle of the IEEE1394 device adapter 100. A first IEEE1394 device adapter 101 is inserted into a first AC power socket 71 in the first room 300. A second IEEE1394 device adapter 102 is inserted into a second AC power socket 72 in the second room 400. The first AC power socket 71 is connected to the second AC power socket 72 through a commercial AC power line 90. The first and second IEEE1394 device adapters 101 and 102 have the same function and structure as the above-mentioned IEEE1394 device adapter 100. The first IEEE1394 device 81 is connected to the IEEE1394 interface 30 of the first IEEE1394 device adapter 101 in the first room 300. The second IEEE1394 device 82 is connected to the IEEE1394 interface 30 of the second IEEE1394 device adapter 102 in the second room 400.

When the first IEEE1394 device 81 in the first room 300 functioning as a signal transmission terminal communicates with the second IEEE1394 device 82 in the second room 400, which is functioning as a signal receiving terminal, the switch unit 60 of the first IEEE1394 device adapter 101 is switched to connect the first conversion circuit 40 to the

IEEE1394 interface 30 of the first IEEE1394 device adapter 101. The switch unit 60 of the second IEEE1394 device adapter 102 is switched to connect the second conversion circuit 50 to the IEEE1394 interface 30 of the second IEEE1394 device adapter 102.

The first IEEE1394 device 81 outputs a data signal to the IEEE1394 interface 30 of the first IEEE1394 device adapter 101. The compassion control chip 41 receives the data signal through the switch unit 60, compresses the data signal into a data packet, and outputs the data packet to the D/A converter 42. The D/A converter 42 converts the data packet into a carrier signal, and outputs the carrier signal to the coupler 43. The coupler 43 couples the carrier signal to an AC voltage and outputs the AC voltage coupled with the carrier signal to the first AC power socket 71. The first AC filter 44 filters noise from the AC voltage coupled with the carrier signal, and outputs the AC voltage coupled with the carrier signal to the AC power line 90 through the AC power plug 20 and the AC power socket 71.

The AC power line 90 transmits the AC voltage coupled with the carrier signal to the second AC filter 54 through the AC power socket 72 and the second power plug 20 in the second room 400. The second filter 54 filters any noise from the AC voltage coupled with the carrier signals, and outputs the filtered AC voltage coupled with the carrier signal to the decoupler 53. The decoupler 53 divides the AC voltage coupled with the carrier signal into the AC voltage and the carrier signal, and outputs the carrier signal to the A/D converter 52. The A/D converter 52 converts the carrier signal into the data packet, and outputs the data packet to the decompression control chip 51 of the second IEEE1394 device adapter 102. The decompression control chip 51 decompresses the data packet into the data signal, and outputs the data signal to the second IEEE1394 device 82 through the switch unit 60 and the IEEE1394 interface 30 in the second room 400. Therefore, the first IEEE1394 device 101 in the first room 300 can communicate with the second IEEE1394 device 102 in the second room 400 through the AC power line 90 without the need for an interconnected computer.

Although numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. An institute of electrical and electronics engineers (IEEE) 1394 device adapter comprising:
an alternating current (AC) power plug to be inserted into an AC power socket to receive an AC voltage;
an IEEE1394 interface to be connected to an IEEE1394 device;
a first conversion circuit comprising a digital to analog (D/A) converter, and a coupler connected between the D/A converter and the AC power plug;
a second conversion circuit comprising an analog to digital (A/D) converter, and a decoupler connected between the A/D converter and the AC power plug; and
a switch unit connected between the IEEE1394 interface and each of the first conversion circuit and the second conversion circuit, to connect either the first conversion circuit or the second conversion circuit to the IEEE1394 interface;
wherein when the switch unit connects the first conversion circuit to the IEEE1394 interface, the D/A converter receives a first data signal output by the IEEE1394 device through the IEEE1394 interface, and converts the first data signal into a first carrier signal, the coupler couples the first carrier signal to an AC voltage, and outputs the AC voltage coupled with the first carrier signal to the AC power plug, the AC power plug transmits the AC voltage coupled with the first carrier signal to an AC power line connected to the AC power socket; and
wherein when the switch unit connects the second conversion circuit to the IEEE1394 interface, the decoupler receives an AC voltage coupled with a second carrier signal through the AC power plug from the AC power line connected to the AC power socket, divides the AC voltage coupled with the second carrier signal into the AC voltage and the second carrier signal, and outputs the second carrier signal to the A/D converter, the A/D converter converts the second carrier signal into a second data signal, and outputs the second data signal to the IEEE1394 device through the IEEE1394 interface.

2. The IEEE1394 device adapter of claim 1, wherein the first conversion circuit further comprises a compression control chip, the compression control chip is connected between the switch unit and the D/A converter to receive the first data signal from the IEEE1394 device through the IEEE1394 interface, and compresses the first data signal into a first data packet, and outputs the first data packet to the D/A converter, the D/A converter converts the first data packet into the first carrier signal; wherein the second conversion circuit further comprises a decompression control chip, the decompression control chip is connected between the switch unit and the A/D converter to receive a second data packet from the AC power line and decompress the second data packet into the second data signal, and outputs the second data signal to the IEEE1394 interface through the switch unit.

3. The IEEE1394 device adapter of claim 1, wherein the first conversion circuit further comprises an AC filter, the AC filter is connected between the coupler and the AC power plug to filter the AC voltage coupled with the first carrier signal output to the AC power line.

4. The IEEE1394 device adapter of claim 1, wherein the second conversion circuit further comprises an AC filter, the AC filter is connected between the decoupler and the AC power plug to filter the AC voltage coupled with the second carrier signal from the AC power line.

5. The IEEE1394 device adapter of claim 4, further comprising a voltage conversion circuit, wherein the voltage conversion circuit comprises an alternating current to direct current (AC/DC) converter and a voltage adjustor, the AC/DC converter is connected between the AC power plug and the voltage adjustor to receive the AC voltage, and converts the AC voltage into a DC voltage, and outputs the DC voltage to the voltage adjustor, the voltage adjustor adjusts the received DC voltage, and outputs the adjusted DC voltage to the IEEE1394 interface to power the IEEE1394 device.
